(19) United States
(12) Patent Application Publication
(10) Pub. No.: US 2010/0159079 A1
(43) Pub. Date: Jun. 24, 2010

(54) Encapsulate and Food Containing Same

(75) Inventor: Fernando Qvyjt, Memphis, TN (US)

Correspondence Address: UNILEVER PATENT GROUP, 800 SYLVAN AVENUE, AG West S. Wing, ENGLEWOOD CLIFFS, NJ, 07632-3100, US

(73) Assignee: Conopco, Inc., d/b/a UNILEVER, Englewood Cliffs, NJ (US)

(21) Appl. No.: 12/343,612

(22) Filed: Dec. 24, 2008

(51) Int. Cl. A23L 1/30; A23L 2/52; A23D 7/00; A23L 1/48; A23L 1/304

(52) U.S. Cl. 426/89; 426/601

(57) ABSTRACT

An encapsulate comprising an outer shell and an inner core formed using sol/gel technology. Preferably the encapsulates are incorporated into foods such as weigh management foods, preferably nutrition bars, ready-to-drink beverages, powdered beverages or soups. In a preferred embodiment, the encapsulate is made using an acid catalyst and releases its contents sufficiently in the human ileum to result in enhanced satiety.

### BACKGROUND OF THE INVENTION

In the last few years, weight reduction has been a focus of preventive medicine. Excessive weight is cited almost daily in reports concerning type 2 diabetes. Moreover, obesity is often mentioned in discussions of other modern diseases, such as heart disease and even cancer.

Many consumers have turned to foods intended for weight management. Examples include nutrition bars, ready-to-drink beverages, powdered beverages and soups. Weight management foods can be used as meal replacements or for supplementing meals as a snack. One desired characteristic for weight management foods is the ability to leave the consumer satisfied following ingestion of a limited number of calories and to thereby delay the need for further intake of calories. That is, some weight management foods aim to increase satiety.

Some nutrients are reported to have enhanced effects on satiety. For example, proteins have been said to promote satiety better than other macronutrients. Other approaches to satiety have also been used. For example, US 2004/0258803 and US2004/0258735 disclose use of encapsulated satiety agents wherein the satiety agent is released predominantly in the intestines, especially the ileum. Release of the satiety agent over more than one part of the intestine is said to be believed to aid efficacy of the agent.

Some ingredients themselves have been proposed for addition to foods for their satiety effects but cannot easily be added, for one reason or another, e.g., for reasons of taste or solubility.

Much public attention has been paid in recent years to a variety of food ingredients which reportedly have beneficial properties for the health. Among the most celebrated of these are the omega-3 fatty acids. One or more of these acids, and/or their sources, have been recommended for numerous conditions, such as high blood pressure, rheumatoid arthritis, undesirable cholesterol levels, mental acuity problems, infections, inflammation and elevated triglycerides. Two of the better known omega-3 fatty acids are DHA (docosahexaenoic acid) and EPA (eicosapentaenoic acid).

While it may be desirable to add omega-3 fatty acids and/or their sources to ingestable formulations, several characteristics of these nutrients make their inclusion in good tasting food products a challenge. For example, since these are polyunsaturated fatty acids, they have a tendency to oxidize and to produce an off-taste after a time.

US Published Patent Application No. US2006/0052351 is directed to compositions comprising a combination of diacylglycerol and phytosterol and/or phytostanol ester(s) dissolved or dispersed in edible oil and/or edible fat, particularly olive, canola and/or fish oil in the manufacture of nutritional supplements and orally administrable pharmaceutical preparations. The supplements are said to be capable of reducing blood levels of both cholesterol and triglycerides and/or for lowering serum, serum LDL and macrophage oxidation levels. The supplements can be in the form of capsules.

Eppler et al. US Patent Application Publication No. 2005/0266137 discloses a food composition comprising from 5 to 30% hydrolyzed protein and a tryptophan source. An object is to provide meal replacement products or other calorie controlled products which have a high protein level but which also maintain good organoleptic properties. As food fat, fish oils, plant oils, seed oils, nut oils and others, or mixtures thereof, may be used. “Monosaturated” and/or polyunsaturated fats and mixtures thereof are said to be particularly preferred. Preferred polyunsaturated fats include omega 3 fatty acids. Optional ingredients include encapsulated satiety agents. The composition may include one or more cholesterol lowering agents such as isoflavones, phytosterols, soy bean extracts, fish oil extracts, and tea leaf extracts. These satiety agents may be encapsulated in any suitable cross-linked encapsulating agent whereby they are predominantly released in the intestines. Encapsulant materials comprising gelatin and at least one of gum arabic, carrageenan, agar agar, alginate or pectins, especially gelatin and gum arabic, have been found to be very suitable. Aldred et al. US Published Patent Application No. US2005/0233045 also mentions encapsulated satiety agents, fish oils, sugar alcohols and phytosterols.

Akimoto et al. US Patent Application Publication No. 2006/0057185 discloses in example 6 capsules which include arachidonic and fish oil.

Ho et al. US Published Patent Application No. US 2006/0052438 is directed to certain compounds and their use, particularly to prevent cancer. Among the many other ingredients mentioned by Ho et al. are plant sterols, fish oil, sorbitol and mannitol. Combinations of ingredients are mentioned. Ho et al.'s invention may be in capsule form. Nanoparticles and microparticles are mentioned.

Ruseler-van Embden et al. US Patent Application Publication No. 2004/0166183 is directed to methods and means for preventing, treating or reducing inflammation comprising subjecting a mammal to a treatment with at least one inhibitor capable of inhibiting proteolytic activity. The composition can be in the form of a rinsing fluid, capsules, or diapers. A long list of potential ingredients is provided. The list includes acetamide, MEA, acetoglyceride, amino acids, beta-sitosterol, DHA, EPA, erythritol, and xylitol and mixtures thereof. Capsules which passage through the esophagus and stomach are mentioned.

Among techniques for encapsulation some involve formation of a sol and then a gel.

Zink et al. WO 93/04196 discloses an active biological material encapsulated in a glass formed using a sol-gel process. A metal alkoxide is mixed with water and exposed to ultrasonic energy at a pH of less than or equal to 2 to form a solution which is then buffered to between about 5 and 7. The buffered solution is then mixed with an active biological material. Protein may be encapsulated in a porous transparent glass. TEOS and TMOS are mentioned as precursor compounds. Base catalysts are said to generate rapid gelation, making control of the process and the production of monoliths extremely difficult.

Lapidot et al., U. S. Patent Application Publication No. US 2006/0251687 is directed to a substantially leachless agent encapsulating sol-gel particles and methods of preparing them and products containing same. A method comprises emulsifying an inner phase containing at least one agent and at least one first sol-gel precursor in an outer phase containing a dispersing medium for obtaining initial sol-gel particles encapsulating the at least one agent and then reacting the initial sol-gel particles with at least one second sol-gel precursor thereby obtaining substantially leachless agent encapsulating sol-gel particles. An average particle size of sol-gel particles is obtained ranging from 0.05 microns to 5 microns in diameter. The particles may be transparent. Preferably an acidic catalyst may be used, although the catalyst may also be basic. A process may be carried out under mild conditions. Double layered sol-gel microparticles result. Colored food additives may be prepared. TEOS (tetraethyl orthosilicate) is used in examples.

Magdassi et al. U.S. Pat. No. 6,303,149 is directed to a process for preparing 0.01-100 micron sol-gel microcapsules loaded with functional molecules and to products made by the process. The process comprises creating an oil-in-water emulsion by emulsifying a water insoluble solution comprising the sol gel precursors and the molecules to be loaded in an aqueous solution under appropriate shear forces, such as a homogenizer, a high pressure homogenizer or a sonicator, and mixing and stirring the emulsion with an aqueous solution at a suitable pH to obtain loaded sol gel microcapsules in suspension. The sol-gel precursors can be a metal or a semi-metal alkoxide monomer, or a partially hydrolyzed and partially condensed polymer thereof, or a mixture thereof. Tetraexthoxy silane (TEOS) is used in several of the examples. The loaded molecules or substances may be any molecules or substances which are soluble or suspendable in the metal or semi metal alkoxide of choice. Food additives and vitamins are listed among numerous examples. The emulsion can be mixed with an aqueous solution at a suitably selected pH, which may be acidic, basic or neutral. The products can be used in various carriers, such as creams and lotions, processed food, sprays, paints, lacquers, coatings, plastics, detergents, etc. Examples including Beta-carotene and lycopene are given. It is said that the resulting powder can be easily suspended in hydrophilic phases such as water, milk, yoghurt, etc.

Harrup et al. Bechtel Technical Paper entitled “Preparation and Characterization of Novel Polymer/Silicate Nancomposities, Functional Condensation Polymers” dated Jan. 1, 2002 discusses the sol-gel process on page 2 et seq. On page 4, syntheses are described wherein polymer is dissolved in THF/ethanol after which TEOS is added. Catalyst is then introduced as an aqueous solution and the mixture capped and sonicated.

Schunk et al. US Patent Application Publication No. 2005/0130827 discloses decomposable (under physiological conditions) monolithic ceramic materials. It is said that the material can be obtained by various sol-gel processes which are essentially characterized in that at least one framework precursor material, at least one substance capable of hydrolyzing the precursor material and at least one water-soluble polymer are combined. TEOS may be used. Acidic catalysts are said to be preferred in that they lead to formation of condensed clusters (nanosize particles). After the components have been combined, the gel is aged after which solvent is removed or replaced, eg by dipping the gel into an aqueous solution having an acidic or basic character. Schunk et al. indicate that a significant development is encapsulation of active compounds, in particular proteins and peptides) which are subject to enzymatic decomposition in nanosize particles and microparticles and transport them through the intestinal wall into the bloodstream. The degree of agglomeration can be chosen so that the monolith remains intact until it enters the intestines and subsequently disintegrates into nanosize particles.

Kessler et al. WO 2007/145573 discloses a process for forming a hydrosol of one or more metal oxides comprising preparing a metal alkoxide solution in a water miscible solvent such as an alcohol, providing an aqueous solvent and mixing the metal alkoxide solution with the aqueous solvent. In example 8, Ti(OPr)₄ is dissolved in PrOH and triethanolamine, ibuprofen and penicillamine are added. Then, hydrolyzing solution comprising HNO₃, and PrOH was added to form an organic sol.

Naigertsik US Patent Application Publication No. 2007/0292676 is directed to microcapsules having a core material encapsulated within a microcapsular shell. A TEOS sol-gel precursor may be used. The capsules may be used in foods and have a particle size within the range of 0.01-1000 um. The release of the active can be delayed. The process for preparing the microcapsules includes preparing an oil in water emulsion by emulsification of an oily phase including a water insoluble precursor and the core material, in an aqueous phase having a pH of 2-7 under appropriate shear forces and temperatures. In example 1, a sunscreen is mixed with TEOS and emulsified in an aqueous solution containing 1% cetyltrimethyl ammonium chloride under high shear forces. The emulsion was mixed with an aqueous solution having a pH of 3.8. A cake of microcapsules was isolated reconstituted in a solution including a pH stabilizer.

Garti et al. US Patent Application Publication No. 2003/0232095 is directed to nano-sized, self-assembled structured concentrates and their use as effective suitable carriers for transferring active components into the human body. The nano-sized concentrates comprise an aqueous phase, an oil phase, a surfactant, a co-solvent and a co-surfactant. Among health benefiting nutriceuticals are mentioned phytosterols used for cholesterol adsorption. The oil phase is a solvent selected from a group which includes C₂₋₂₄ fatty acids or their esters and glycerol mono, di and triesters and sterols. Sterols may also comprise the co-solvent. Other co-solvents mentioned include sorbitol and xylitol.

Makino et al. US Patent Application Publication No. 2003/0232076 is directed to a soft gelatin capsule agent comprising a gelatin having specified sol-gel transition temperatures, a plasticizer, and an anti-adhesion agent.

ZETA—POTENTIAL MEASUREMENTS IN BIOACTIVE COLLAGEN, L. Andrade, R. Z. Domingues Departamento de Química—ICEx—Universidade Federal de Minas Gerais. Av. Antõnio Carlos, 6627, CEP 31270-90, Belo Horizonte, Brazil, an abstract for which is published in SBPMat, BRAZIL-MRS, 2^{nd} Brazilian MRS Meeting, Oct. 26-29, 2003, Symposium B: Advances in Biomaterials II, discusses the influence of charge surface on the bioactivity of intentionally modified collagen fiber surface. Silica obtained from a sol-gel process was used as agent for surface modification.

NITRIC OXIDE SENSOR PREPARED BY SOL-GEL ENTRAPMENT OF IRON(III)-DIETHYLDITHIOCARBAMATE IN A SILICA MATRIX, J. P. Melo Jr., J. C. Biazzotto, C. A. Brunello, \C. F. O Graeff, DFM-FFCLRP-USP, 14040-901 Ribeirão Preto, Brazil, an abstract for which is published in SBPMat, BRAZIL-MRS, 2^{nd} Brazilian MRS Meeting, Oct. 26-29, 2003, Symposium B: Advances in Biomaterials II, discloses of synthesis of a NO sensor, SGFe3DETC, by entrapment of iron(III)-diethyldithiocarbamate (Fe3DETC), within a silica matrix by the sol-gel process.

TERNARY HYBRID ORGANO-INORGANIC COMPOSITES BASED ON SILICA, CHITOSAN AND POLYMONOMETHYLITACONATE ^{a}P. Jaime Retuert, ^{a}Yadienka Martinez, ^{b}Mehrdad Yazdani-Pedram; Centro para la Investigación Interdisciplinaria Avanzada en Ciencia de los Materiales (CIMAT) and ^{a}Facultad Cs. Físicas y Matemáticas, Universidad de Chile, Av. Beaucheff 850, Casilla 2777, Santiago, Chile ^{b}Facultad Cs. Químicas y Farmacéuticas, Universidad de Chile, Olivos 1007,Casilla 233, Santiago, Chile. an abstract for which is published in SBPMat, BRAZIL-MRS, 2^{nd} Brazilian MRS Meeting, Oct. 26-29, 2003, Symposium B: Advances in Biomaterials II, indicates that using the sol-gel method, a network-forming precursor sol and organic compounds can be combined to develop materials with interesting characteristics, including chemical stability. Sol-gel processing of tetraethoxysilane (TEOS) with acid catalysts was used.

Jones et al. “Novel Processing of Silica Hydrosols and Gels” J. Non-Crystalline Solids, 101, (1988), 123-126 discusses a technique for producing silica hydrosols from TEOS without solvent addition or intense agitation. The typical alkoxide route to silica gels is said to comprise the catalyzed reaction of TEOS and water in a mutual solvent.

Kong et al. WO 2006/084339 is directed to a process, which may involve a sol-gel process, for producing layered nanoparticles via a water-in-oil micoemulsion. Hydrolyzable species such as TEOS may be used. The catalyst may be a strong acid, an organic acid, a base, an amine, a fluorde or a transition metal alkoxide. The inventors indicate that advanced controlled release technology may find applications not only in traditional applications for controlled release systems such as food, chemical, biocide, pesticide, pharmaceutical and cosmetic, but also in other areas.

Kong et al. WO 2006/133518 discloses a process for preparing particles having a hydrophobic material therein using sol-gel technology and multiple emulsions. A first emulsion is dispersed in a hydrophobic medium. The first emulsion comprises a hydrophobic phase dispersed in a hydrophilic phase. The hydrophobic phase comprises the hydrophobic material and the hydrophilic phase comprises a precursor capable of reacting to form a non-fluid matrix. The particles may be used to release a hydrophobic component which may be a drug or other therapeutic agent. The hydrophilic phase may be prepared by combining a crosslinkable species, such as TEOS, with water. High shear may be employed in forming the first emulsion. An acid or base catalyst may be used. On page 57, Kong et al. discuss the influence of synthesis pH on release rate. Kong et al. indicate that release of encapsulated oil can be controlled by controlling the porosity of the silica matrix, which may be controlled by adjusting the pH of the hydrophilic phase. At pH<2, the quantity of the pores and the size of the pores decreases, thus slowing the release of the oil.

Barbe et al. U.S. Pat. No. 7,258,874 and US 2005/0123611 disclose controlled release ceramic particles which may be prepared by a sol-gel process. Process 3 involves preparing a precursor solution including a gel precursor and an active ingredient, preparing a condensing solution by mixing a catalyst and a condensing agent which need not be water, combining the precursor solution and condensing solution to form an emulsion in the absence of surfactant, forming and aging controlled release ceramic particles. The catalyst may be an acidic or basic catalyst. The internal microstructure of the spheres can be precisely tailored by varying parameters such as water:alkoxide ratio, pH, alkoxide concentration, aging, and drying time and temperature. Hence the release ratio of the active ingredient is controlled by adapting the structure of the internal pore network to the properties of the active ingredient. Other patent documents cited by Barbe et al. as disclosing matrices prepared by sol-gel processes include U.S. Pat. No. 5,591,453, GB 1 590 574, WO 9745367 and WO 0050349.

Finnie et al. WO 2006/133519 is directed to a process for making particles comprising a hydrophobic dopant for subsequent release. The process comprises providing an emulsion having a hydrophilic phase and a hydrophobic phase dispersed therein. Precursor material is reacted to form particles comprising the dopant. The precursor and the dopant are present in the hydrophobic phase.

Seok et al. US Patent Application Publication No. US 2004/0256748 is directed to a process for preparing silica microcapsules which includes dissolving TEOS into an aqueous solution of hydrolysis catalyst and adding a core material and an amount of aminopropyltrialkoxysilane (APS) as a gelling agent.

Bruinsma et al. U.S. Pat. No. 5,922,299 discloses a surfactant-templated nanometer scale porosity silica precursor solution and forming a mesoporous material by first forming the silica precursor solution into a preform and then rapid drying or evaporation. The silica precursor can be an alkoxide silica precursor such as TEOS. The silica precursor is mixed with a surfactant in an aqueous solution together with an acid catalyst. Preferred surfactants contain ammonium cation.

Martens et al. US Patent Application Pub. No. 2007/0275068 is directed to controlled release delivery systems comprising a bioactive compound and a matrix carrier. The matrix carrier is an amorphous microporous non-fibrous silicon or titanium oxide loaded with bioactive compound. A two step procedure is used wherein the matrix carrier is synthesized first and then the bioactive agent is introduced into the matrix carrier. Martens et al. mention that the texture and properties of sol-gel processed silica materials prepared using TEOS depend upon the chemical composition, temperature and pH during gel formation, and drying conditions. The connectivity of the silicate network and the porosity are said to be dependent upon the water/alkoxide ratio and the nature of the catalyst. Martens et al. indicate that amorphous microporous silica suitable for controlled release drug delivery systems can be prepared under acid catalyzed sol-gel conditions at low water contents. TEOS may be used. It is said that particle size can be easily adapted and adjusted in the range from nanometers to millimeters. A number of potential bioactive agents are described.

Babich et al. US 2003/0082238 is directed to sol gel matrices encapsulating a reaction center. A large number of possible reaction centers are mentioned. In paragraph 0299, TMOS is added to HCl solution to begin the matrix synthesis.

Jokinen US 2007/0196427 discloses methods for preparing a sol-gel derived SiO2 with a very fast bioresorption rate from a sol comprising water, an alkoxide and a lower alcohol using a mineral acid or base as a catalyst.

Finney, WO 2006/066317 is directed to a process for releasably encapsulating a biological entity. The process comprises combining a solution of a surfactant in a non-polar solvent with a precursor material and the biological entity to form an emulsion. In one embodiment the process comprises combining a precursor material and a biological entity to form a polar mixture, adjusting the pH of the polar mixture to between about 7.5 and about 11, combining the polar mixture with a solution of a surfactant to form an emulsion having a polar phase dispersed in a non-polar phase, the polar phase including the polar mixture and forming particles comprising the biological entity from the polar phase. In example 2, 100 mg of sample are dispersed in 2 mls of PBS in the case of subtilisin and alpha-chymotrypsin and an ethanol buffer (pH=9.5) in the case of alkaline phosphatase. FIG. 16 shows the release of alpha-chymotrypsin, subtilisin and alkaline phosphatase over a period of eight hours.

### SUMMARY OF THE INVENTION

The invention is directed to a process for encapsulating active materials using a sol gel technique, and to encapsulates made thereby, suitable for use in foods, especially foods designed for weight management. The invention is also directed to the foods and processes for making and using them.

Sol-gel is a technique for encapsulating ingredients which is flexible enough to accommodate different particle size, forms, application modes, etc. Bitter ingredients or others susceptible to oxidation or other degradation, or needed as slow release are among some ingredients which can be expected to benefit. The product can be made in various forms, such as monoliths, films, mono-sized powders and fibres.

Sol-gels can be formed at low temperatures and converted to glasses without a high temperature melting process (i.e. can be produced at room temperatures). The sol-gel process involves the evolution of inorganic networks through the formation of a colloidal suspension (sol) and gelation of the sol to form a network in a continuous liquid phase (gel). The precursors for synthesizing these colloids are a metal or metalloid element surrounded by various reactive ligands. Metal alkoxides, especially metal alkoxysilanes, are most popular because they react readily with water, for food purposes. Metal or semi-metal alkoxide monomers or a partially hydrolyzed and partially condensed polymer thereof, or any mixture thereof may be used as precursors.

The encapsulates of the invention are particularly suitable to use in weight management, e.g., for use to stimulate the so-called ileal brake wherein satiety agents are delivered directly to the ileum. Encapsulates of the invention can be tailored for use in ileal brake by synthesizing the encapsulates under conditions which promote resistance to degradation under the low pH/high acid conditions of the stomach and which promote release in the higher pH conditions of the intestines. Alternatively, or in addition, the encapsulates of the invention may be used to mask bitter, “fishy” or other undesirable taste properties.

The encapsulates of the invention are preferably made utilizing sol-gel technology by mixing, at room temperature and with high shear, tetraethoxy silane (TEOS) or another metal- or semi-metal alkoxide (or mixture thereof) with the core material which is to be encapsulated, e.g., phytosterol, fish oil or a mixture thereof, preferably essentially without any solvent added, especially preferably without volatile solvent, e.g., hexane, cyclohexane, methanol or ethanol. Some solvent, such as alcohol, may be generated in the reaction, depending on the starting materials. It is not necessary or recommended to apply heat to the reaction. Indeed, it is preferred to conduct the process at ambient temperature, e.g., from 70-80 oC, especially from 72-78 oC. Generally, the reaction will be exothermic and the reaction temperature will increase as described below without application of heat. Preferably, the ingredients are mixed at a high shear prior to the addition of any catalyst, which is typically an acid or a base catalyst. Appropriate shear would preferably be within the range of from 600 to 15,000 rpm. The total time for imposing high shear preferably ranges to from 0.5 to 1440 minutes, preferably from 5 to 10 minutes. Shear may be continued at a lower rate after addition of the catalyst. Preferably, no heat or cooling is applied prior to the neutralization step of adding acid or base.

Although it is not necessary to apply heat to the reaction, it may be desirable to apply heat where higher melting reactants are used (e.g. not liquid at room temperature) so that they can react as liquids.

Any mixer capable of achieving high shear may be used, such as Silverson mixers. Unlike some processes in the art, in the present invention it is not preferred to disperse the mixture of TEOS (or other metal or semi-metal alkoxide) to form an emulsion prior to addition of catalyst, or to include an HLB emulsifier. Indeed, preferably no emulsion is formed prior to addition of catalyst.

Preferably, it is not necessary to form more than one layer around the encapsulate. That is, preferably the encapsulate is not multi-layer.

In a preferred embodiment, the amount of water present prior to addition of acid or base catalyst during formation of the encapsulate is minimized. That is, the ingredients to be encapsulated and the materials used to form the shell are preferred to have no available water and are especially preferred to be water-free. Preferably, less than 1 wt % water form any source (even that normally present in some organic solvents like ethanol), more preferably, less than 0.5 wt % water, and most preferably less than 0.05 wt % water is present in the initial reaction mixture for forming the encapsulate.

The reaction mix used to form the encapsulated agents herein preferably have insubstantial amounts of organic solvent; more preferably they are free of organic solvent. Preferably, less than 1 wt 5, especially less than 0.5 wt %, more preferably less than 0.05 wt % and most preferably no organic solvent is present. Solvents which are preferably present in insubstantial amounts, and which more preferably are excluded, from the sol gel reaction herein include organic solvents such as decanol, castor oil, hexane, acetone, THF, chloroform, dichloromethane, dimethylformamide, diethyl ether, tetrachloromethane, and alcohols such as ethanol, methanol, propanol, isopropanol, etc., as well as other organic solvents such as esters, ketones, aldehydes, nitriles and the like, paraffin oil, other hydrophobic solvents such as silicon oil, and combinations thereof.

The reaction mix used to form the encapsulated agents herein preferably are free of surfactants, particularly HLB surfactants, and especially cationic surfactants. Preferably, less than 1 wt %, especially less than 0.5 wt % , more preferably less than 0.05 wt % and most preferably, no surfactant is present. Surfactants which are preferably excluded from the sol gel reaction herein include ammonium cations such as quaternary ammonium cations like cetyltrimethylammonium chloride, or tertiary ammonium cations, alkyl trimethyl ammonium chloride or bromide surfactants, hexadecyltrimethylammonium bromide, Polysorbate 20, Polysorbate 40, Polysorbate 60, Polysorbate 65, Polysorbate 80, Polysorbate 85, Sorbitan laurate, Sorbitan palmitate, Sorbitan stearate, Sorbitan tristearate, Sorbitan oleate, Sorbitan sesquioleate, trioleate Sorbitan, Simulsol 988/989 (PEG-7 Hydrogenated Castor oil), PEG-35-Castor oil, PEG-40 Castor Oil, PEG-25-Hydrogenated Castor oil, PEG-40-Hydrogenated Castor oil, PEG-60-Hydrogenated Castor oil, Mix sorbitan ester, sodium oleate and poloxamers. Of course there may be situations where it is desirable to encapsulate an agent which has some emulsifying or other surface active properties, in which case such agent will be included in the reaction mix.

The reaction mix used to form the encapsulated agents herein preferably are free of viscosity modifying agents. Preferably, less than 1 wt %, especially less than 0.5 wt %, more preferably less than 0.05 wt % and most preferably no viscosity modifying agents are present. Viscosity modifying agents which are preferably excluded from the sol gel reaction herein includes without limitation, hydroxypropyl cellulose, ethyl cellulose, other celluloses such as, for example, hydroxypropyl methyl cellulose, methyl cellulose, hydroxyethyl cellulose and the like, acrylates such as, for example, sodium acrylate copolymers, paraffinium liquidum and PPG-1 trideceth-6, as well as PVP, maltodextrin, xantham gum, carbomers, lecithins, guar gum and wax.

The reaction mix used to form the encapsulated agents herein preferably are free of ingredients other than the core material to be encapsulated, the sol-gel precursor (e.g. metal or semi-metal alkoxide), the catalyst and ultimately the component (usually acid or base) needed to stop the reaction. Examples of such preferably excluded components include thickeners and gelling agents, anti-caking agents, anti-foaming agents, water soluble polymers, bulking agents, carriers and carriers solvents, emulsifying salts, firming agents, flavor enhancers, flavor treatment agents, foaming agents, glazing agents, humectants, modified starches, packaging gases, propellants, raising agents and sequestrants. Preferably less than 1 wt %, especially less than 0.5 wt %, more preferably less than 0.05 wt % and most preferably none of such additional components are present in the encapsulation reaction mix. Examples of preferably excluded water soluble polymers include uncharged water soluble polymers such as poly(ethylene oxides), poly(vinylpyrrolidones), poly(acrylamides), polyols such as poly(ethylene glycols), polyols with formamide, ionic polymers such as polyacrylates, poly(alkali metal styrene sulfonates), poly(allylamines) and combinations thereof.

In its preferred form, the present invention involves encapsulating the active ingredients, i.e., forming a shell around the ingredient rather than placing the ingredients in a pre-formed capsule. As indicated above, preferably a single encapsulation procedure is used; that is, it is not preferred in the present invention to encapsulate the encapsulations so as to obtain two or more shells.

Utilizing solgel technology to encapsulate food ingredients, by use of acid or base catalysis, the form of the encapsulate and the reaction time can be influenced. Low pH catalysis favors formation of films, fibers, nanotubes and larger particles. The reaction is instantaneous. On the other hand, high pH catalysts favor spherulites and nanoparticles. Curing times for these of greater than 2 weeks are not uncommon.

The process for making the sol-gels according to the invention does not suffer from side reactions. Obviously, this would be a special concern for food applications. For instance, to be edible crystals should not be glassy; they should be amorphous and edible. Preferred products according to the invention are not glassy.

In accordance with the present invention, the core substance may include ingredients such as fish oils, a water in oil emulsion, sugar alcohols, vegetable oils, fatty acids such as omega-3 fatty acids, phytosterols and esters such as phytosterol esters and mixtures thereof.

Bitter tasting pharmaceutical compounds can benefit from encapsulation in accordance with the invention. Such pharmaceutical compounds include aspirin (acetyl salicylic acid), salicylates, ranitidine, urea, quinine, and acetaminophen.

The invention is further directed to food products, particularly weight management products, which include the encapsulates according to the invention. Foods in which the encapsulates according to the invention can desirably be used include, without limitation, RTD (ready-to-drink) beverages, nutrition bars (including meal replacement and snack bars), sweet powders such as powdered beverages (to be reconstituted by addition of liquids such as water or milk), bakery products and pasta. Preferably the foods of the invention include less than 2 wt % silica. Other foods for which the invention if believed to be useful include soups, baked goods, frozen confections, such as ice cream, sorbet and frozen yogurt, and cereals.

The present invention is also directed to a process for inducing satiety in an animal, such as a human, by feeding the encapsulates prepared according to the invention to that individual. The invention is also directed to a process of preparing a food product by incorporating the encapsulates into the food product.

The advantages of the present invention can be at least two-fold. First, ingredients which would be difficult to include as a food ingredient for one reason or another, e.g. high oxidation rate, bitter taste, etc., can be encapsulated to mask that property or protect the ingredient. Secondly, the encapsulates can be prepared to disintegrate at high pH. pH is low in the stomach and higher in the small intestines, so such encapsulates will survive the high acid environment in the stomach and disintegrate in the intestines. This can be expected to increase the satiety effect, as explained in US 2004/0258803 and US 2004/0258735. A further potential advantage is that the encapsulates can be used in foods such as beverages to visibly suspend particles.

An advantage of the present process is that the solgel process of the invention fully encapsulates the oil or other active ingredient.

For a more complete understanding of the above and other features and advantages of the invention, reference should be made to the following description of the preferred embodiments.

### BRIEF DESCRIPTION OF THE DRAWINGS

FIG. 1 is a graph showing the results of the lipolysis experiment described in Example 6.

FIG. 2 is a graph showing the results of the experiment described in Example 10.

### DETAILED DESCRIPTION OF THE INVENTION

Where sol-gel is used to create a shell using tetraethoxy silane (TEOS), a preferred procedure is as follows. The basic reaction is TEOS+COREMATERIAL—(IN PRESENCE OF CATALYST)—→(COREMATERIAL+SiO₂)+ETOH. Mix the core ingredients (eg, phytosterol and omega-3 oil) and shell ingredient(s) (e.g., TEOS) at 10000 rpm for 5-10 minutes (high shear) in a Silverson mixer. Upon addition of the HCl catalyst, lower the shear to 4000 rpm. The catalyst is added when a homogeneous mixture is obtained. The reaction is initiated at room temperature, but is exothermic and typically reaches a temperature within the range of 120-180° F. or higher. Neutralization is initiated when temperature starts rising and chlorine is released. The gas is trapped in a small glass vessel (5 cc) containing 2 cc of water and causes a rapid drop in pH of water from 7 to 2 or below detected by using pH strips. The neutralization process is carried out very slowly at or above 140° F. with sodium hydroxide solution. The reaction is stopped at 160-190° F. After the reaction has been stopped, the product is mixed for 3 minutes at 200 rpm and then washed with aqueous ethanol, e.g., ethanol 95%, to remove NaOH. The product is then vacuum dried or dried using an alternative drying process. Sol gel clusters of up to 2 cm are typically obtained. The clusters are then ground gently.

Examples of metals and semi-metals, the alkoxides of which can be used in the encapsulating material, include silicon, zinc, zirconium and titanium.

Where the sol gel encapsulate is being prepared for the purpose of inducing satiety, or for some other reason an acid-resistant shell is desired, an acid catalyst is employed as described above, preferably hydrochloric acid. Prior to addition of the catalyst, the ingredients are mixed at a shear rate of from 600 to 5,000 rpm, especially about 4000 rpm for a period of from 5 to 300 seconds. The catalyst is then added. As mentioned, the reaction is an exothermic one, so the temperature of the reaction mixture increases as the reaction proceeds. At a temperature within the range of 90 to 158° F., especially 140° F., the mixture is neutralized slowly by gradual addition of a base, such as sodium hydroxide.

After neturalization, when the reaction reaches a temperature within the range of 135 to 203° F., especially 190° F., the reaction is stopped by reducing the shear because of the fast condensation and polymerization. Then the reaction mixture is mixed for from 5 to 300 seconds, especially 180 seconds at a shear rate of from 50 to 600, especially 200 rpm and subsequently washed with a solvent such as an alcohol, like 95% ethanol, to remove salt produced by the neutralization reaction. The mixture is then dried by vacuum drying or some other drying process.

Upon drying, sol gel clusters of up to 2.5 cm or so in length are produced. The clusters are then subjected to a gentle grinding step. The grinding step may, for instance, be effected using a mortar, balls or hammer grinders or dull blade grinders. The result is a sol gel encapsulation of the core material. The encapsulate (including the shell) preferably has a diameter of above 10 nanometers up to and including 200 microns. Most preferably, less than 2% by weight of the encapsulates have a diameter of 100 nanometers or less and less than 98 wt % has a diameter of above 200 microns. The resulting shell is resistant to, and remains intact upon, exposure to an acidic environment. The shell loses its integrity with higher pH's starting at about 7.2. These acid-resistant shells are expected to be particularly useful for applications where it is desired to deliver a core ingredient to the ileum of the digestive system to produce or enhance the sensation of satiety. The shells are resistant to very acidic environments, so it can be expected that they will retain their integrities in the stomach and stay intact until they pass into the small intestine. Experiments have shown that at the pH of the small intestine as the shells proceed through the intestines, some shells can be expected to lose their integrity over time, but a sufficient number would retain their integrity sufficiently to deliver the core product, e.g., fish oil and/or phytosterol, into the ileum.

Where acid catalysis is employed for sol-gel, it is preferred that the encapsulate is at least 5wt % silica (silica 5 wt % of combination of shell and its contents) to avoid having the shell open prematurely in the stomach. If a minimum of around 5 wt % silica is used, it is believed that sufficient product will release in the ileum for a satiety effect. At less than about 5 wt % silica, the capsule may lose its integrity in the stomach, even with use of an acidic catalyst, such that the shell's content will be depleted in the stomach and the ileal brake effect may not materialize.

For encapsulates which are prepared for a reason other than enhanced satiety and other than having a shell which disintegrates upon exposure to an acidic environment, the process for preparing the encapsulate is the same, except that a base such as sodium hydroxide is used as the catalyst and an acid such as hydrochloric acid is used for neutralization. The resulting shell loses its integrity in an acidic environment. The resulting product can then be expected to be more water soluble and can dissolve in the stomach. An example would be for the encapsulation of an ingredient to mask bitterness or improve water solubility.

Preferably the silica shell prepared using sol-gel completely surrounds the shell contents.

Encapsulating can provide numerous possible benefits, such as stability from oxidation, masking bad taste, mouthfeel or aroma of an ingredient, improving or imparting water solubility, controlled release, and reduced ingredient interaction.

Droplets or particles of the loading substance or core preferably have an average diameter of less than 100 microns, more preferably less than 50 microns, even more preferably less than 25 microns, possibly less than 10 microns. Even droplets or particles of less than 5 microns, 3 microns or 1 micron may be used as measured by any typical equipment known in the art, e.g., a LS230 Particle Size Analyzer available from Coulter of Miami, Fla. Preferably the loading substance is provided in an amount of from about 1% to about 15% by weight of the mixture of core and encapsulating agent, more preferably from about 3% to about 8% by weight, especially about 6% by weight.

If desired, several sol gel precursors may be used together in a mixture.

The particle sizes of our encapsulates can vary from nanoparticles, e.g., as small as 1×10⁻⁹ meters up to, preferably 200 microns, especially from 10 nanometers to 5 microns. More preferred are particle sizes above 100 nanometers, especially more than 2% of the average particle size is greater than 100 nm. Preferably less than 2% of the particles by weight are below 100 nm, more preferably less than 0.1% of the particle by weight are below 100 nm, most preferably less than 0.005 wt % and especially no particles are below 100 nm. The particles size of the encapsulate depends upon factors such as the process conditions, for example, time, temperature, shear, the catalyst employed, and the nature of the core.

Ingredients such as DHA, EPA, DHA/EPA and sources thereof, other omega-3 oils, polyunsaturated fatty acids (PUFA's) and sources thereof, omega 6 fatty acids and sources thereof, e.g., for hunger control, monounsaturated fatty acids (MUFA) and sources thereof such as olive oil and sunflower oil, other oils such as palm oil, sterols, lycopene, antioxidants, essential oils, vitamins, minerals, flavonoids and other polyphenols, pro- and pre-biotics, flavors, aromas, glucosamine, inulin, Nutriose, isomaltulose, dextrins or other starches, glucose, mogrosides (Lo Han Kuo), spices, oils, resins or their extracts, theanine for attention or mood improvement, catechins such as epigallocatechin gallate for reasons such as antioxidant and anti-inflammatory effects are just a few of the potential active ingredients which may be encapsulated for use in foods in accordance with the invention. End products including the encapsulates according to the invention may be prepared in various ways, eg, extruded, baked, etc.

Conjugated linoleic acid (CLA) may be encapsulated herein. CLA has been mentioned as promoting favorable distribution of weight, e.g.; more muscle mass and less fat. Sources of CLA include Loders Croklaan of Channahon, Ill.

Encapsulation can be used in the present invention to promote slow release of aromas to influence taste.

Among the preferred ingredients which may be encapsulated are phytosterol and/or phytostanol and/or their esters, especially their fatty acid esters. The sterols and stanols used in the present invention are those which are available from plants. Sterols can be classified in three groups, 4-desmethylsterols, 4-monomethylsterols, and 4,4′-dimethylsterols. In oils they mainly exist as free sterols and sterol esters of fatty acids although sterol glucosides and acylated sterol glycosides are also present. There are three major phytosterols, namely, beta-sitosterol, stigmasterol and campesterol. The phytostanols are the respective 5 alpha-saturated derivatives of phytosterols such as sitostanol, campestanol and their derivatives. Synthetic analogues of any of the phytsterols or phytostanols (which include chemically modified natural components) may also be used. Esters of acids other than long chain fatty acids, such as oryzanol, may be used. Preferably the phytosterol and/or phytsterol ester is present at least 450 mg per 100 grams of the shell contents (exclusive of the shell itself).

Amino acids which are preferably encapsulated are those having a bitter taste such as theanine, arginine, histidine, isoleucine, leucine, methionine, phenylalanine, tyrosine and valine.

Catechins are flavonoids and are polyphenolic antioxidants. They can be found in certain plants. They are present in the tea plant Camellia sinensis as well as the seeds of the cocoa plant, Theobroma cacao. The best known catechin is perhaps epigallocatechin gallate (EGCG). Other catechins include catechin (C), epicatechin (EC), gallocatechin (GC), epigallocatechin (EGC) and the gallates such as EGCG, gallocatechin gallate (GCG), Epicatechingallate (ECG), and catechin gallate (CG). In addition to tea and cocoa plants, catechins can be found in certain fruits, vegetables, and wine, e.g., bark (e.g. tea), grapes, wine, chocolate, apples, berries, etc.

Lycopene is a carotenoid believed to have favorable health effects. Carotenoids, such as lycopene, have been investigated in connection with prostate cancer, macular degeneration, gingivitis, atherosclerosis, male infertility, oral submucous fibrosis, and oral leukoplakia. Preferred levels are 1-1000 mg per gram of sterols, preferably 2-30 mg of lycopene per 1 g of sterols. A preferred dosage of lycopene is 2-30 mg per day. Other carotenoids which may be usefully employed in the present invention include astaxanthin, zeaxanthin and lutein. An advantage to inclusion of carotenoids, especially the aforementioned carotenoids, in a shell with a phytosterol or ester thereof is that the phytosterol limits the diffusion of the carotenoid when the shells are placed in water.

Rhubarb extract has been reported to have beneficial health effects, including effects relating to weight management, hot flashes, and pancreatic cancer, among others.

Quinine is an alkaloid well known for its anti-malarial effects. Other benefits reported include fever reduction, analgesic effect and as an anti-inflammatory.

Preferably, the core ingredients are used in combination. So, the encapsulate preferably comprises an outer shell and an inner core, the inner core comprising an ingredient selected from phytosterols and/or their esters and at least one of the following groups: a-j:
a) Amino acids;
b) catechins;
c) rhubarb extract
d) quinine
e) pharmaceuticals (for example, acetyl salicylic acid, statins, DMSO)
f) vitamins and minerals, especially cations such as potassium, calcium, magnesium, copper, and iron, zinc, manganese, cobalt, molybdenum, chromium or combinations thereof) and
g) A protein or proteinaceous material
h) A peptide or a polypeptide
i) Lycopene
j) CLA.

It can be expected that the presence of phytosterol and/or phytostanols and/or phytosterol and or phytostanol esters will stabilize the other ingredient in the capsule providing, eg enhanced oxidative stability or controlled release by limiting diffusion.

Preferably, the encapsulate comprises at least four of the above components a-j, preferably a sugar alcohol such as isomaltitol, a sugar such as isomaltulose, a dextrin like cyclodextrin, a phytosterol, and an oil containing at least 0.1 wt % omega-3 fatty acid moieties such as DHA.

In place of or in addition to isomaltitol, various sugar alcohols may be used, such as maltitol, sorbitol and/or erythritol.

The omega-3 oil may comprise at least 0.1 wt % of DHA moieties, EPA moieties, ALA (alpha linolenic acid) moieties or mixtures thereof.

When an oil comprising at least 0.1 wt % of polyunsaturated fatty acid moieties is used, preferably at least 1 grams up to 8 grams per gram serving are present. About 3 grams reaching the illeum is used to cause a satiety effect.

In a preferred embodiment, the invention combines at least two of the aforementioned components a-j, and preferably at least three, more preferably at least four, of the components, to deliver agents which have been reported to improve health such as omega-3 oils and phytosterols. The encapsulate may be designed to deliver the health benefit agent(s) and/or the satiety agent(s) to the small intestine of the person ingesting it, particularly to the ileum. While not wanting to be bound by theory, it is believed that delivery of the health benefit and/or satiety agent(s) to the small intestine promotes satiety. Moreover, when including the health benefit agent in the encapsulate the health benefit agent serves the dual function of health benefit agent and promoting satiety at the same time.

The formulations according to the invention can be expected to have a very good shelf life, yet may include polyunsaturated fatty acids, especially fish oils, which generally have a tendency to oxidize. It is expected that the encapsulated oils will be less susceptible to oxidation and the off tastes which accompany oxidation.

Especially where encapsulation is used to mask undesirable tastes, the encapsulated ingredients may be combined with sweeteners such as sugars, FOS, bitterness masking agents, artificial sweeteners, such as high intensity artificial sweeteners, etc.

If desired, any pro oxidants in the formulation such as copper and other metals, can be encapsulated as well, e.g., with carnauba wax and/or other waxes or with other encapsulating materials described herein.

The unsaturated fatty acids can be present as free fatty acids, but more typically will be present esterified to glycerol as mono-, di- or most preferably tri-acylglycerols. Unless otherwise required by context, references to any unsaturated fatty acids herein includes also reference to sources thereof such as triacylglycerols.

The present invention may be used to incorporate any polyunsaturated fatty acid in the food and mixture thereof, and most especially to incorporate omega-3 and/or omega-6 fatty acids and/or esters of omega 3's and/or 6's and mixtures thereof. Among the polyunsaturated fatty acids for which the invention may be useful are included arachidonic acid, docosahexaenoic acid (DHA), eicosapentaenoic acid (EPA), linoleic acid, linolenic acid (alpha linolenic acid) and gamma-linolenic acid and mixtures thereof. The fatty acids and/or sources may be included in combinations described above in a preferred embodiment (e.g., at least two of components a through f), or may be encapsulated by themselves or with other components.

Among sources for the unsaturated acids which are encapsulated in accordance with the invention may be included vegetable oils, marine oils such as fish oils and fish liver oils and algae. Possible vegetable oil sources include olive oil, soybean oil, canola oil, high oleic sunflower seed oil, high oleic safflower oil, safflower oil, sunflower seed oil, flaxseed (linseed) oil, corn oil, cottonseed oil, peanut oil, evening primrose oil, borage oil, and blackcurrant oil. In addition, other oils/fats, and extracts which may be encapsulated herein are palm oil, tarragon oil, clove oil, cardamom oil, thymol, carvacrol, anise, cinnamon oil, oregano oil, arnica, basil, bergamot, calendula, caraway, chamomile, cinnamon, citrus, elder, eucalyptus, fir needle, garlic, hops, juniper, lavender, lemon balm, licorice, marjoram, passionflower, peppermint, primrose, and thyme.

The food of the invention may be any of several foods which could be supplemented with and/or contain pro-oxidant minerals and polyunsaturated fatty acids. Preferably the food is a nutrition bar, a ready-to-drink beverage, a sweet powder such as a powdered beverage, a soup, or a frozen confection. The food components mentioned in this application may be included in the encapsulate or outside the encapsulate.

Preferably, foods of the invention include at least 0.5%, especially at least 2%, more preferably at least 4% by wt. of the encapsulate of the invention. For ileal brake, it is preferred that from 1-8 g, especially at least 3 g of the satiety agent reach the ileum. Preferably, the core material comprises at least 5 wt. %, preferably at least 15 wt. %, especially at least 30 wt. % of the encapsulate.

The food of the invention may include protein sources. Preferred sources of protein include sources of whey protein such as whey protein isolate and whey protein concentrate, sources of rice protein such as rice flour and rice protein concentrate, and sources of pea protein. Soy protein may also be used. The protein may be present in the food in discrete nuggets, in the encapsulate, other forms, and any combination thereof.

Additional dairy protein sources include one or more of dairy protein source, such as whole milk, skim milk, buttermilk, condensed milk, evaporated milk, milk solids non-fat, etc. The dairy source may contribute dairy fat and/or non-fat milk solids such as lactose and milk proteins, e.g. the whey proteins and caseins. Especially preferred, to minimize the caloric impact, is the addition of protein as such rather than as one component of a food ingredient such as whole milk. Preferred in this respect are protein concentrates such as one or more of whey protein concentrate as mentioned above, milk protein concentrate, caseinates such as sodium and/or calcium caseinate, isolated soy protein and soy protein concentrate. Total protein levels within the foods of the invention, particularly when the food takes the form of a nutrition bar, are preferably within the range of 3 wt % to 50 wt %, such as from 3 wt % to 30 wt %, especially from 3 wt % to 20%.

When protein nuggets are employed, they typically include greater than 50 wt % of protein selected from the group consisting of milk protein, rice protein and pea protein and mixtures thereof, especially between 51 wt % and 99 wt %, more preferably between 52 wt % and 95 wt %, most preferably 55 wt % or above. Other ingredients which may be present in the nuggets would include one or more of other proteins, such as those listed above, include lipids, especially triglyceride fats, and carbohydrates, especially starches. Particularly where the nuggets are made using the moderated temperature extrusion process described below, it is advisable that the remaining ingredients be no more sensitive to heat degradation (e.g., have the same or lower degradation point) than the selected non-soy protein.

The food of the invention may include various oils or fats whether as unsaturated fatty acids moieties encapsulated herein or elsewhere in the food. In addition to those mentioned above, such oils and fats include other vegetable fat, such as for example, cocoa butter, illipe, shea, palm kernal, sal, cottonseed, coconut, rapeseed, and corn oils, or mixtures thereof. A blend of oils (e.g., canola, soybean, or high oleic oils) may be used, especially containing either synthetic antioxidants such as BHT, TBHQ or natural antioxidants such as mixed tocopherols, ascorbic acid and rosemary extract or a blend of the above. When the source is for linoleic and linolenic acids (C18:2 and C18:3), straight oil or blends of oil such as canola plus soybean with an appropriate antioxidant system can be used. Natural antioxidants which may be suitable include extracts from laurel and basil prepared by hydrodistillation. However, animal fats such as butter fat may also be used if consistent with the desired nutritional profile of the product.

An especially preferred blend of oils for use in the bars, pastas, powdered beverages, soups and other foods of the invention is a blend of canola and soybean oils at a weight ratio canola to soybean of from 35:65 to 65:35, especially about 50:50. This may be used within the shell or outside of the shell. The blend may be used in the bars and other foods of the invention at levels of from 2 to 25 wt %, especially from 5 to 20 wt %, most especially from 8 to 12 wt %. The blend provides a good, stable source of omega-3 and omega-6 fatty acids. For instance, levels of 0.15 to 0.2 g/serving of omega-3 and 1 to 2 g per serving of omega-6 are readily provided by the canola/soybean blend in food having an excellent shelf life as long as 12 or even 14 months. The canola/soybean blend preferably includes antioxidants, in particular BHT or TBHQ or a combination of ascorbic acid and rosemary extract, preferably at levels of 50 to 3000 ppm.

In general, where encapsulated oils containing PUFA moieties are used in accordance with the -invention, added antioxidants such as tocopherols, ascorbic acid and/or rosemary extract may be omitted; that is, the oils may be essentially free of added antioxidants, especially free of added antioxidants. Where non-encapsulated oils containing PUFA moieties are used, it is preferred that added antioxidants such as tocopherols, ascorbic acid and/or rosemary extract be present in the oil.

Polyunsaturated fats, particularly those containing omega-3 and omega-6 fatty acids, are preferably incorporated as encapsulates in accordance with the invention.

Carbohydrates can be used in the foods of the invention at levels of from 0 to 90%, especially from 1% to 49%. In addition to sweeteners, the fibers and the carbohydrate bulking agents mentioned below, examples of suitable carbohydrates include starches such as are contained in rice flour, flour, peanut flour, tapioca flour, tapioca starch, and whole wheat flour and mixtures thereof. Levels of carbohydrates in the bars or other foods of the invention will typically comprise from 5 wt % to 90 wt %, especially from 20% to 65 wt %.

If it is desired to include a bulking agent in the food, within or external to the nuggets or capsules/microcapsules, a preferred bulking agent is inert polydextrose. Polydextrose may be obtained from Danisco under the brand name Litesse®. Other conventional bulking agents which may be used alone or in combination include maltodextrin, sugar alcohols, corn syrup solids, sugars or starches. Total bulking agent levels in the foods, e.g., nutritional bars, of the invention, will preferably be from about 0% to 20 wt %, preferably 5% to 16%.

Flavorings are preferably added to the food or nutrition bar in amounts that will impart a mild, pleasant flavor. The flavoring may be in nuggets or the encapsulates/microencapsulates or external to the nuggets and the encapsulates/microencapsulates in the bar or other food, provided that processing is not adversely affected. The flavoring may be any of the commercial flavors employed in nutrition bars or other foods, such as varying types of cocoa, pure vanilla or artificial flavor, such as vanillin, ethyl vanillin, chocolate, malt, mint, yogurt powder, extracts, spices, such as cinnamon, nutmeg and ginger, mixtures thereof, and the like. It will be appreciated that many flavor variations may be obtained by combinations of the basic flavors. The nutrition bars or other foods are flavored to taste. Suitable flavorants may also include seasoning, such as salt (sodium chloride) or potassium chloride, and imitation fruit or chocolate flavors either singly or in any suitable combination. Flavorings which mask off-tastes from vitamins and/or minerals and other ingredients are preferably included in the products of the invention, in the encapsulates/microencapsulates, in protein nuggets and/or elsewhere in the product. Preferably, flavorants are present at from 0.25 to 3 wt % of the food, excluding salt or potassium chloride, which is generally present at from 0 to 1%, especially 0.1 to 0.5%.

The capsules, any nuggets and the bar or other food may include colorants, if desired, such as caramel colorant. Colorants are generally in the food at from 0 to 2 wt %, especially from 0.1 to 1%. Preferably the encapsulates and their contents do not contain HLB emulsifiers. Accordingly, any emulsifiers present in the encapsulates and their contents are emulsifying proteins or carbohydrates. The product may, however, contain eggs as desired.

If desired, the food, especially any nuggets, may include processing aids such as calcium chloride.

In general, it is preferred not to use emulsifiers, particularly HLB emulsifiers, in the process of making the sol-gel, but they may be present in the overall end product e.g., nutrition bar. Typical emulsifying agents may be phospholipids and proteins or esters of long chain fatty acids and a polyhydric alcohol. Lecithin is an example. Fatty acid esters of glycerol, polyglycerol esters of fatty acids, sorbitan esters of fatty acids and polyoxyethylene and polyoxypropylene esters of fatty acids may be used but organoleptic properties, of course, must be considered. Mono- and di-glycerides may be used as well. Emulsifiers may be used in any emulsions used to spray dry the unsaturated fatty acids in amounts of about 0.03% to 0.3%, preferably 0.05% to 0.1%. The same emulsifiers may also be present in the nutrition bar or other food and/or protein nuggets, again at levels overall of about 0.03% to 0.3%, preferably 0.05% to 0.1%. Emulsifiers may be used in combination, as appropriate. Any nuggets may also include emulsifiers.

Emulsions may be formed in a homogenizer such as a high pressure homogenizer from Invensys APV of Tonawanda, N.Y. The emulsion will typically comprise from 5 wto/o to 25 wt % of carrier and 35 to 15 wt % of the unsaturated fatty acid. The emulsion typically will have about 40% solids and the balance water.

Among fiber sources which may be included in the foods of the invention are fructose oligosaccharides (fos) such as inulin, guar gum, gum arabic, gum acacia, oat fiber, cellulose, whole grains, and mixtures thereof. The compositions preferably contain at least 2 grams of fiber per 56 g serving, especially at least 5 grams of fiber per serving. Preferably, fiber sources are present in the product at greater than 0.5 wt. % and do not exceed 6 wt. %, especially 5 wt. %. As indicated above, additional bulking agents such as maltodextrin, sugar alcohols, corn syrup solids, sugars, starches and mixtures thereof may also be used. Total bulking agent levels in the products of the invention, including fibers and other bulking agents, but excluding sweeteners will preferably be from about 0% to 20%, especially from 1 to 15 wt %. The fiber and the bulking agent may be present in the food as a whole, e.g., the nutrition bar, and/or in capsules, nuggets, etc. provided that processing is not impaired.

Carrageenan may be included in the bars or other food of the invention, internal or external to the shells and nuggets, eg, as a thickening and/or stabilizing agent (0 to 2 wt % on product, especially 0.2 to 1%). Cellulose gel and pectin are other thickeners which may be used alone or in combination, e.g., at 0 to 10 wt %, especially from 0.5 to 2 wt %.

Typically, if the food is a nutrition bar, or in any of a number product forms which are generally sweet, the food will be naturally sweetened. The sweetener may be included in the encapsulates/microencapsulates and/or in any nuggets or elsewhere in the bar or food provided that it does not interfere with the processing of the capsule or nugget. Sources of sweetness include sucrose (liquid or solids), glucose, fructose, and corn syrup (liquid or solids), including high fructose corn syrup, corn syrup, tagatose, maltitol, corn syrup, high maltose corn syrup and mixtures thereof. Other sweeteners include leucrose, trihalose, lactose, maltose, isomaltulose, glycerine, brown sugar sucromalt, and galactose and mixtures thereof. Polyol sweeteners other than sugars include the sugar alcohols such as maltitol, xylitol, isomalt and erythritol. Levels of sweeteners and sugar sources preferably result in sugar and/or other polyol solids levels of up to 20 wt %, especially from 10 to 17 wt % of a nutrition bar or ready to drink beverage.

Other polysaccharides which may be included in the encapsulates or elsewhere in the food include modified or unmodified starches, including dextrins, maltodextrins, and cyclodextrins and the high fiber dextrin product sold by Roquette under the name Nutriose®.

If it is desired to use artificial sweeteners, these may likewise be present in the microcapsule and/or nugget and/or within the bar or other food external to the nugget, provided that it does not interfere with processing. Any of the artificial sweeteners well known in the art may be used, such as aspartame, saccharine, Alitame® (obtainable from Pfizer), Acesulfame K (obtainable from Hoechst), cyclamates, neotame, sucralose, mixtures thereof and the like. The artificial sweeteners are used in varying amounts of about 0.005% to 1 wt % on the bar or other food of the invention, preferably 0.007% to 0.73% depending on the sweetener, for example. Aspartame may be used at a level of 0.05% to 0.15%, preferably at a level of 0.07% to 0.11%. Acesulfame K is preferred at a level of 0.09% to 0.15%.

Calcium may be present in the nutrition bars or other foods at from 0 to 100% of RDA, preferably from 10 to 30% RDA, especially about 25% RDA. The calcium source is preferably dicalcium phosphate. For example, wt. % levels of dicalcium phosphate may range from 0.5 to 1.5%. In a preferred embodiment, the product is fortified with one or more vitamins and/or minerals and/or fiber sources, in addition to the calcium source. These may include any or all of the following:

Ascorbic acid (Vitamin C), Tocopheryl Acetate (Vitamin E), Biotin (Vitamin H), Vitamin A Palmitate, Niacinamide (Vitamin B3), Potassium Iodide, d-Calcium Pantothenate (Vitamin B5), Cyanocobalamin (Vitamin B12), Riboflavin (Vitamin B2), Thiamine Mononitrate (Vitamin B1), Molybdenum, Chromium, Selenium, Calcium Carbonate, Calcium Lactate, Manganese (e.g., as Manganese Sulfate), Magnesium (e.g., as magnesium phosphate), Iron (e.g., as Ferric Orthophosphate) and Zinc (as Zinc Oxide). The vitamins and minerals are preferably present at from 5 to 100% RDA, especially 5 to 50% RDA, most especially from about 15% RDA. The vitamins and/or minerals may be included within, or external to, the encapsulates and any nuggets, provided that processing and human absorption are not impaired. Encapsulation in accordance with the present invention of vitamins can be expected to improve Stability and reduce off-notes (e g, for vitamins C, E, B12, etc.) Minerals which tend to be pro-oxidants, such as iron, may be included in the encapsulated form according to the present invention.

RDA as referred to herein is the Recommended Dietary Allowances 10^{th} ed., 1989, published by the National Academy of Science, National Academy Press, Washington, D.C.

Encapsulation of cations (e.g. calcium, magnesium, zinc, iron, manganese, cobalt, molybdenum, copper, chromium or combinations thereof) to avoid undesirable reactions with other ingredients (e.g. alginates, PUFA's, MUFA's, vitamins, etc.)

Encapsulated sources of copper or other pro-oxidants are preferably used in the foods of the invention. Encapsulated pro-oxidants are preferably present at a level of from 15 to 100% RDA. Preferred are encapsulated copper salts such as microencapsulated cupric gluconate available from the Wright Group of Crowley, La. Another pro-oxidant copper salt which could benefit from encapsulation according to the present invention is copper sulfate. Encapsulated pro-oxidant salt products available from Wright include the following available under the name SuperCoat™: We 101266 (Iron), We 101265 (zinc): We 101270 (copper) and We 101267 (manganese). Encapsulated pro-oxidant salts are preferably present in the food of the invention at a level of from 0.3 to 0.85% by wt.

If desired, the pro-oxidants and other components of the invention may be coated with an edible wax, such as beeswax, carnauba wax, candellia wax, paraffin wax or mixtures thereof. Preferably the wax has a melting point greater than 65 oC. Alternatively, the pro-oxidant can be coated with another coating material which provides resistance to food processing conditions/variables such as temperature, shear, moisture and oxygen levels, such as stearic acid, hard fats, edible waxes, cellulose and protein. Examples of hard fats include hydrogenated soy bean or cotton seed oils. Preferably, the pro-oxidants are completely coated by the wax or other encapsulating agent.

Ingredients which, if present, will generally be found within a bar but external to the encapsulates and/or any nuggets include, but are not limited to, rolled oats, chocolate or compound chips or other chocolate or compound pieces, cookie and/or cookie dough pieces, such as oatmeal cookie pieces, brownie pieces, fruit pieces, such as dried cranberry, apple, etc., fruit jelly, vegetable pieces such as rice, honey and acidulants such as malic and citric acids, leavening agents such as sodium bicarbonate and peanut butter.

The foods of the invention may be made by known methods. The encapsulates are added to the foods at a convenient time in the processing, provided that they are not exposed to temperatures which cause degradation of their ingredients. Likewise, if protein-containing nuggets are present, the processor must be sensitive to any conditions which could cause degradation of the nugget.

Extruded nutritional bars may be made by cooking a syrup containing liquid (at ambient temperature) ingredients and then mixing with dry ingredients. The mixture is then extruded onto a conveyor belt and cut with a cutter. Any nuggets, e.g., protein nuggets, are included among the dry ingredients. The encapsulates/microencapsulates and any nuggets should only be added to the syrup when the syrup is at a temperature below that at which any of the encapsulates/microencapsulates or nugget components degrade. Syrup ingredients may include components such as corn syrup, glycerine (0-20 wt % on total product, especially 0.5 to 10 wt %), lecithin and soybean oil or other liquid oils. In addition to the capsules and any nuggets, other dry components include grains, flours (e.g., rice or peanut), maltodextrin and milk powders.

Nutritional bars in the form of granola bars may be made by cooking the syrup, adding the dry ingredients, blending the syrup and dry ingredients in a blender, feeding the blended mix through rollers and cutting with a cutter.

The bars of the invention may be coated, e.g., with milk chocolate or yogurt flavored coating. Chocolates with little or no milk or milk products may be considered so as to maximize the presence of chocolate antioxidants and, if and to the extent desired, to try to avoid reported neutralization of antioxidants in the chocolate by milk or its components.

Typically, excluding moisture lost during processing, the uncoated bars of the invention will be made from 30-50 wt % syrup, especially 35-45%, and 50-70 wt % dry ingredients, especially 55-65 wt %. Generally, coated bars according to the invention will be made from 30-50 wt % syrup, especially 35-45 wt %, 40-50 wt % dry ingredients, especially 40-45% and 0-30 wt % coating (e.g., chocolate or compound coating), especially 5-25 wt %, particularly 10-20 wt % coating.

Any nuggets preferably contain greater than 50 wt %, especially greater than 60%, more preferably greater than 70 or 80% proteins, especially non-soy proteins selected from the group consisting of milk protein, rice protein and pea protein.

It can be expected that the benefits of the invention will be realized in various types of foods, including various types of nutrition bars including, without limitation, snack bars and meal replacement bars. One example would be granola bars. Other applicable foods include soups and sweet powders which may be used to sweeten, flavor and fortify beverages such as milk, and ready-to-drink beverages.

Soups according to the invention are prepared by dry mixing the ingredients, as is known in the art. All seasoning is added to a ribbon blender (powder mixer). Mixing takes between 12 and 15 minutes depending upon the number of ingredients and size of the batch in the mixer. The mix is placed into a large tote that is taken to the packaging line.

In the case of powdered beverages, the product will typically be made using the following process. The ingredients are scaled to the quantity dictated in the formulation. The scaled ingredients are placed in a sifter placed over a 20 mesh standard screening unit. The ingredients are then bumped though the standard screen. The screened ingredients are emptied into a container, the lid is sealed and then the container is shaken vigorously for at least two minutes. The contents of the container are emptied into a 20 mesh standard screen and then stored in an air tight container. Beverages are typically prepared by scaling out the appropriate serving size of powder, scaling out 8 oz. of refrigerated skim milk, pouring milk into a blender vessel, turning the blender to a low setting and adding powder to the agitating skim milk, covering the blender vessel with an appropriate closure, increasing the speed to mid-high power, agitating at mid-high power for 20-30 seconds and then stopping agitation. The beverage is typically served and consumed shortly after preparation.

Sieve Analysis and the Saturn DigiSizer® (a Laser Light Scattering instrument using the Mie and Fraunhofer Theories with Dry Sample Dispersion) techniques may be used to measure the particle size (average particle diameter).

An example of preparation of a ready to drink beverage is as follows (See example 8). Water at ambient conditions and cellulose are mixed in a high shear mixer for 5 minutes. The mix is transferred into a cold kettle A set at 50°. The oil in water emulsion is then added. Separately, the lecithin, gums, mono & di glycerides, and water at 155° F. are high-shear-mixed for 15. Then the soy protein, calcium casinate, Non Fat Dry Milk, and cocoa are added and mixed for 4 minutes. The mix is then transferred to a hot kettle set at 170° F. and homogenize at 500/2000 psi. Subsequently, this mix is transferred to the cold kettle A. Flavors, sugars, premix, and phosphates are dissolved in water under agitation for 5 minutes. Then the solution is sent to the cold kettle A and mixed for 15 minutes. pH is adjusted to 6.8-7.0. The solids content is then adjusted after adding the solgel. The product is then sterilized and cooled thru UHT @ 287° F. for 9 seconds, then cooled to 170° F. and finally homogenized 0/500 psi and filled at 70° f in Dole cans.

DSC and TGA can be used to determine if there is a glassy state and whether there is a side reaction. Typically, a side reaction would generate a shift in the glass transition and generation of volatiles during heating. DSC may be performed on a Perkin Elmer Pyris system. The cycle consists of heating the sample from room temperature to 80° C., holding then cooling to −60°, holding and reheating to 80°. TGA may be performed using a Perkin Elmer TGA7. The cycle consists of heating a sample rapidly from room temperature to 140° C., then holding the sample at this temperature

### EXAMPLE 1

### Encapsulation of Canola Oil

| Ingredient | Weight [g] |
|---|---|
| Canola oil | 100 |
| Tetraethoxysilane | 250 |
| HCl (pH = 0.1) | 20 |
| NaOH (pH = 11) | 6 |

Canola oil was mixed with the TEOS (Dynasylan A™ from Degussa). The mixture was at 64° F., mixed at 10,000 rpm for three minutes. Then the hydrochloric acid was added until the temperature rose to 112° F. The sodium hydroxide solution was then slowly added. The temperature started rising and when it reached 120° F. the speed was rapidly reduced to 1000 rpm while temperature kept rising to 148° F. The exothermic reaction lasted about 20 seconds. During the reaction time ethanol was collected in a trap cooled with a mixture of dry ice and isopropyl alcohol (e.g., ˜15° F.). The speed was reduced to about 400 rpm. When the product cooled off, a solution of Ethanol 95% was added to wash off some of the sodium chloride formed.

The precipitated product was then placed in a vacuum cell at room temperature with a cold trap (˜15° F.) that retained the ethanol and volatiles. The dried product (canola oil completely encapsulated by silica) was collected 24 hours later with a 99.98% recovery of solids.

### EXAMPLE 2

The “center” of a coated bar is formed from the following components:

| Component | Wt % of Center |
|---|---|
| Protein | 25 |
| Sugar | 8 |
| Rice cereal | 16 |
| Soy protein | 6 |
| Vitamin/mineral | 4 |
| mix (including | |
| microencapsulated | |
| cupric gluconateex | |
| Wright Group) | |
| Sodium chloride | 0.5 |
| Corn syrup | 28.5 |
| Molasses | 4 |
| Peanut butter | 4 |
| Encapsulated product | 4 |
| (made by procedure | |
| of Example 1) | |

The liquid components are mixed, after which the dry ingredients are added and mixed until the product is substantially homogeneous. The encapsulated product of Example 1 is added with the dry components. The mixture is then fed into a die and extruded at room temperature and atmospheric pressure. Upon extrusion, the bar is cut into individual serving sizes which are then coated with a chocolate confectioner's compound coating. The bar is packaged and kept at 85° F. for 12 weeks, after which it is opened and eaten. No off taste is detected. Each week of successful storage at 85 oF is believed to equate to one month of successful storage at ambient temperature.

### EXAMPLE 3(a)

### Encapsulation of a 50:50 Blend of Palm Oil and Sunflower Oil

| Ingredient | Weight [g] |
|---|---|
| Palm oil | 133.08 |
| Sunflower Oil | 133.08 |
| Tetraethoxysilane | 1032.42 |
| HCl (pH = 0.1) | 10.66 |
| NaOH (pH = 11) | 28.81 |

The palm oil and the sunflower oil were blended at 95° F. (the oils needed to be heated because palm oil is solid at room temperature) and then mixed with the TEOS (Dynasylan A™ from Degussa) at 10,000 rpm for three minutes. The hydrochloric was added until the temperature rose to 110° F. The sodium hydroxide solution was then slowly added as pH in the water trap dropped from 7 to 1.8. The temperature started rising, and when it reached 122° F. the speed was rapidly reduced to 1000 rpm while temperature kept rising to 148° F. The exothermic reaction lasted about 35 seconds. During the reaction time, ethanol was collected in a trap cooled with a mixture of dry ice and isopropyl alcohol (e.g., ˜15° F.). The speed was reduced to about 400 rpm. When the product cooled off, a solution of Ethanol 95% was added to wash off some of the sodium chloride formed.

The precipitated product was then placed in a vacuum cell at room temperature with a cold trap (˜15° F.) that retained the ethanol and volatiles. The dried product was collected 24 hours later with a 99.98% recovery of solids.

### EXAMPLE 3(b)

### Encapsulation of a 50:50 Blend of Palm Oil and Sunflower Oil

| Ingredient | Weight [g] |
|---|---|
| Palm oil | 183.46 |
| Sunflower oil | 185.96 |
| OSAN starch | 5.09 |
| Isomaltulose | 1.61 |
| H₂O | 9.79 |
| Tetraethoxysilane | 430.31 |
| HCl (pH = 0.1) | 82.14 |
| NaOH (pH = 11) | 104.28 |

The thick aqueous phase A containing Isomaltulose, OSAN starch, and water was made by mixing the ingredients at 4000 rpm at about 95° F. OSAN starch is starch reacted with octenylsuccinic anhydride. The oil phase B containing palm oil and sunflower oil was blended at 95° F. The aqueous solution A and the oil phase B were mixed together at 10,000 rpm to form an emulsion C. The emulsion C was then mixed with the TEOS (Dynasylan A™ from Degussa) at 10,000 rpm for three minutes. The hydrochloric acid was added until the temperature rose to 110° F. The sodium hydroxide solution was then slowly added. The temperature started rising quickly; when it reached 122° F. the speed was rapidly reduced to 1000 rpm while temperature kept rising to 148° F. The exothermic reaction lasted about 30 seconds. During the reaction time, ethanol was collected in a trap cooled with a mixture of dry ice and isopropyl alcohol (e.g ˜15° F.). The speed was reduced to about 400 rpm because of the fast formation of large clusters with an average length of 2.5 cm. When the product cooled off, a solution of Ethanol 95% was added to wash off some of the sodium chloride formed.

The precipitated product was then put in a vacuum cell at room temperature. A cold trap (˜15° F.) was set in-line to retain the ethanol and other possible volatiles. The dried product was collected 24 hours later with a total 99.99% recovery of solids.

### EXAMPLE 4

| | |
|---|---|
| Water | 325 g |
| SolGel canola | 6.5 g |

The SolGel encapsulates prepared in a similar way as those of Example 1 were added to water and stirred at room temperature. The product solubilized and formed a very thin emulsion without any precipitation. No traces of free-oil were observed. Confocal microscopy and electron microscopy showed a very thin silica layer coating the oil.

### EXAMPLE 5

| | |
|---|---|
| Skim Milk | 325 g |
| SolGel Canola | 6.5 g |

The SolGel capsules prepared in a similar way as those of Example 1 were added to cold skim milk and stirred. The product solubilized and formed a very thin emulsion without any precipitation. No traces of free oil were observed.

### EXAMPLE 6

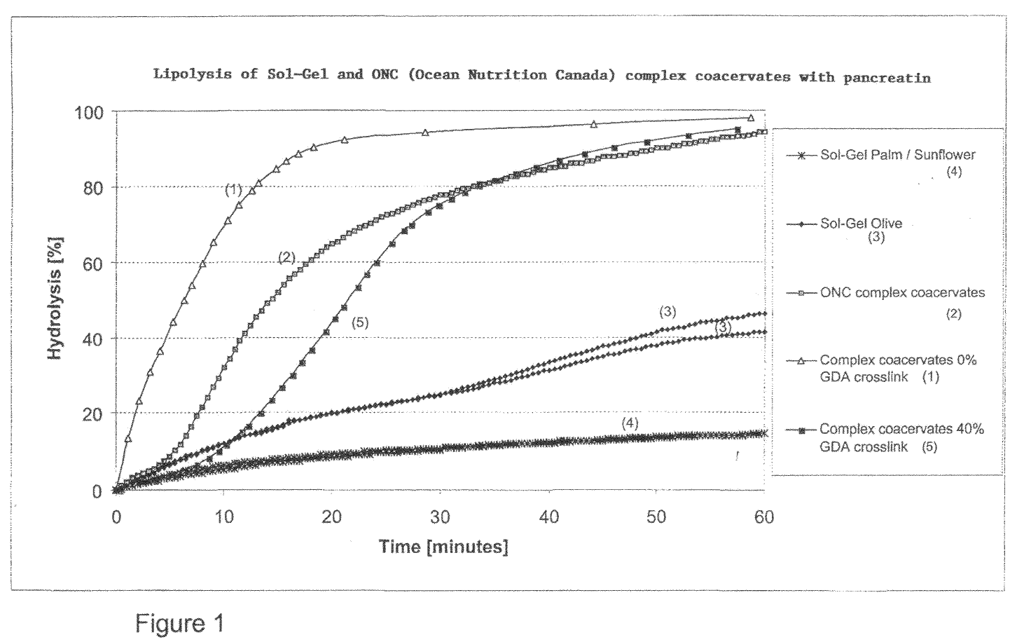

Lipolysis experiments were prepared with pancreatin and bile on SolGel batches. An in-vitro lypolysis test showing its efficacy to possibly deliver active ingredients in the ileum break. The results are seen in FIG. 1.

Materials and Equipment

Bile (ox gall powder), tris(hydroxymethyl)aminomethane maleate, calcium chloride and porcine pancreatin (1× USP) were obtained from Sigma, USA.

0.10 M sodium hydroxide solution (Titrisol) was obtained from Merck, Germany.

pH stat analysis was performed on a DL55 titrator (Mettler Toledo, Switzerland) which was connected to a personal computer. Instrument control was performed via LabX light titration software. The incubation vessel of the titrator (60 ml) was thermo stated with a M3 water batch (Lauda, Germany).

Standard Lipolysis Assay

The measuring principle of this assay is as follows: pancreatin is a broad mixture of different types of enzymes with proteases and lipases as the predominant ones. When SolGel is added to the incubation mixture, a slow release of triglycides is observed. Secondly, the free oil droplets are hydrolysed by lipases of the pancreatin in free fatty acids and monoglycerides. The produced free fatty acids will result in a drop of the pH of the incubation solution, which is automatically compensated by the addition of sodium hydroxide solution via the titrator (pH stat mode). The molar amount of sodium hydroxide solution added is equal to the molar amount of fatty acids formed during the hydrolysis of triglycerides. For calculation of the degree of hydrolysis of triglycerides it was assumed that pancreatic lipase hydrolyses 1 mole of triglycerides into 2 moles of fatty acids and 1 mole of mono-glycerides. This is the sodium hydroxide use as the measuring signal.

For lipolysis measurements, an incubation buffer of 40 mM sodium chloride, 2 mM tris (hydroxymethyl) aminomethane maleate and 80 mM calcium chloride was prepared. The pH of the buffer was adjusted with 0.10 M sodium hydroxide solution to 6.8. For each lipolysis assay 40 ml of incubation buffer, 1.0 g of bile and 500 mg of SolGel were mixed. The lipolysis reaction was started with the addition of 25 mg of pancreatin powder. During the incubation period of 60 minutes, automatic addition of sodium hydroxide solution was performed to maintain a pH value of 6.8 (pH stat). The temperature during the lipolysis assay was kept constant at 37° C.

A graph showing the results is presented in FIG. 1.

GDA is glutardialdehyde.

The graph shows that the olive and palm/sunflower oils encapsulated via a sol gel procedure using an acid catalyst (#3 and #4) showed slower oil release than for various complex coacervates. No glassy state was observed for the solgels. The solgel fully encapsulated the oil or active ingredient. The reactions were controlled to produce solgel particles greater than 1 micron. The results suggest that the solgels could be able to reach the ileum break more efficaciously.

### EXAMPLE 7

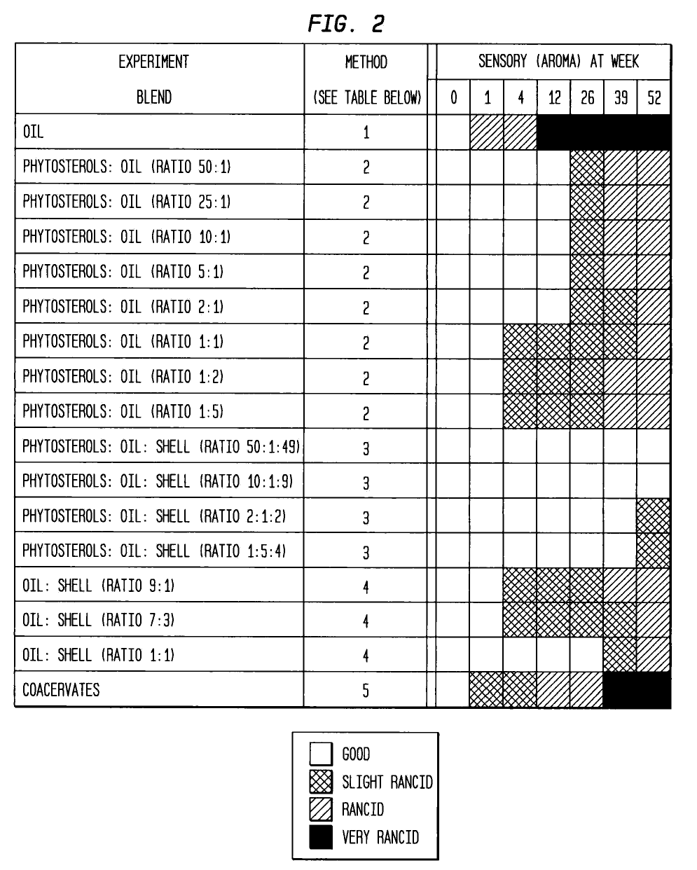

The stability of fish oil in various environments was tested as shown in FIG. 2. The greatest stability was seen where the oil was encapsulated together with phytosterols. The capsules were prepared using the sol gel method of the invention according to the method indicated in the graph (one of the following methods 1-5).

| Method | Description |
|---|---|
| 1 | 100 g of Unimeg-38 (fish oil with TDS XOU38.01/Unilever) from Ocean |
| | Nutrition of Dartmouth, Nova Scotia, Canada (ONC) were poured into 200 g |
| | glass containers. The jars were kept open (without the lid) in an incubator at |
| | 25° C. and 75% relative humidity. Sensory tests were conducted at 0, 1, 2, 4, |
| | 12, 26, 39, and 52 weeks. |
| 2 | Phytosterols were poured in a glass container and melted at about 85° C. The |
| | fish oil from ONC was added and mixed. The blend was rapidly cooled to |
| | 15° C. The mass was cryo-milled using liquid nitrogen. The fine powder was |
| | maintained in a dry chamber (~0% relative humidity) to avoid water |
| | condensation while being packed under vacuum. Once the system reached |
| | room temperature, 100 g samples were poured into 200 g glass containers. |
| | The jars were kept open (without the lid) in an incubator at 25° C. and 75% |
| | relative humidity. Sensory tests were conducted at 0, 1, 2, 4, 12, 26, 39, and |
| | 52 weeks. |
| 3 | SolGels were prepared using samples from method 2 above following similar |
| | procedure as shown in Example 1 above. 100 g samples were poured into |
| | 200 g glass containers. The jars were kept open (without the lid) in an |
| | incubator at 25° C. and 75% relative humidity. Sensory tests were conducted |
| | at 0, 1, 2, 4, 12, 26, 39, and 52 weeks. |
| 4 | SolGels using Unimeg-38 (fish oil with TDS XOU38.01/Unilever) from Ocean |
| | Nutrition Canada (ONC) were prepared following a similar procedure as the |
| | one depicted on Example 1 above. 100 g samples were poured into 200 g |
| | glass containers. The jars were kept open (without the lid) in an incubator at |
| | 25° C. and 75% relative humidity. Sensory tests were conducted at 0, 1, 2, 4, |
| | 12, 26, 39, and 52 weeks. |
| 5 | 100 g of Meg-3 (Omega-3 DHA powder, TDS MC60TDHA-NGH.01) from |
| | Ocean Nutrition were poured into 200 g glass containers. The jars were kept |
| | open (without the lid) in an incubator at 25° C. and 75% relative humidity. |
| | Sensory tests were conducted at 0, 1, 2, 4, 12, 26, 39, and 52 weeks. |

### EXAMPLE 8

A meal replacer beverage having the following composition is prepared by the process indicated below.

| Component | % wt |
|---|---|
| Water | 80 |
| Vitamin mineral mix | 0.5 |
| Mono & Di glycerides | 0.2 |
| Flavor | 0.4 |
| Phosphates | 0.28 |
| Lecithin | 0.095 |
| Gums | 0.715 |
| Non Fat Dry Milk | 6.1 |
| Cellulose | 0.6 |
| Cocoa | 1.2 |
| Sugars | 2.1 |
| Caseinate | 0.6 |
| Soy Protein | 0.018 |
| Oil in water Emulsion | 0.0-6.5 |
| SolGel | 0.5-4 |

Process

Mix and Blend of Batch

Water at ambient conditions and cellulose are mixed in a high shear mixer for 5 minutes. The mix is transferred into a cold kettle A set at 50°. The oil in water emulsion is then added. Separately, the lecithin, gums, mono & di glycerides, and water at 155° F. are high-shear-mixed for 15. Then the soy protein, calcium casinate, Non Fat Dry Milk, and cocoa are added and mixed for 4 minutes. The mix is then transferred to a hot kettle set at 170° F. and homogenized at 500/2000 psi. Subsequently, this mix is transferred to the cold kettle A. Flavors, sugars, premix, and phosphates are dissolved in water under agitation for 5 minutes. Then the solution is sent to the cold kettle A and mixed for 15 minutes. pH is adjusted to 6.8-7.0. The solids content is then adjusted after adding the solgel. The product is then sterilized and cooled thru UHT @ 287° F. for 9 seconds, then cooled to 170° F. and finally homogenized 0/500 psi and filled at 70° f in Dole cans.

If desired, any of the components which are mentioned for encapsulation herein may also be present, alone or in combination, in the product outside of capsules in addition to or instead of in the encapsulated form. However, the benefits of encapsulation have been pointed out herein.

By HLB emulsifier is meant an emulsifier having an HLB value. Therefore, as used herein “HLB emulsifiers excludes proteins, sterols, etc. which have an emulsifying action but which lack an HLB value.

It will be appreciated that when fatty acids are mentioned herein, generally these will present in the form of glycerides such as mono-, di- and triglycerides. Therefore, “fatty acids” encompasses glycerides containing them. The saturated fatty acid content refers to the weight percentage of saturated fatty acid residues in the oil. The term “unsaturated fatty acid content” refers to the weight percentage of unsaturated fatty acid residues in the oil. The term “monounsaturated fatty acid content” means the weight percentage of monounsaturated fatty acid residues in the oil. “Polyunsaturated fatty acid content” refers to the weight percentage of polyunsaturated fatty acid residues in the oil.

All ranges stated herein include all individual values and subranges of said values.

Unless stated otherwise or required by context, the terms “fat” and “oil” are used interchangeably herein. Unless otherwise stated or required by context, percentages are by weight.

As used herein “essentially free” and “substantial absence” mean that less than 0.1 wt % of that ingredient is present.

The word “comprising” is used herein as “including, but not limited to” the specified ingredients. The words “including” and “having” are used synonymously.

It should be understood of course that the specific forms of the invention herein illustrated and described are intended to be representative only, as certain changes may be made therein without departing from the clear teaching of the disclosure. Accordingly, reference should be made to the appended claims in determining the full scope.

What is claimed is:

1. An active ingredient fully contained within a silica matrix.

2. The encapsulate according to claim 1 wherein the outer shell comprises polymerized monomers of metal- or semi-metal alkoxide.

3. The encapsulate according to claim 2 wherein the alkoxide is an alkoxide of zirconium, silicon, titanium, aluminum and/or boron.

4. The encapsulate according to claim 3 wherein at least one silicon-based alkoxide is used to produce a silicon-based polymer.

5. The encapsulate according claim 1 wherein the active ingredient comprises an oil having includes at least 5 wt % DHA moieties.

6. The encapsulate according claim 1 wherein the active ingredient comprises an oil having includes at least 10 wt % DHA moieties, EPA moieties, ALA moieties or mixtures thereof.

7. The encapsulate according to claim 1 comprising an inner core including
a) phytosterol; and
b) isomaltulose.

8. A food product comprising the encapsulate of claim 1.

9. A process of making a food product comprising mixing the encapsulate according to claim 1 with other food ingredients.

10. A nutrition bar comprising the encapsulate of claim 1.

11. A ready-to-drink beverage comprising the encapsulate of claim 1.

12. A sweet powder comprising the encapsulate of claim 1.

13. An ingestable encapsulate comprising an outer shell formed from one or more metal- or semi-metal alkoxide monomers and an inner component encapsulated by the shell wherein the encapsulate is formed by dissolving, or forming a homogeneous solution or suspension of, the inner component in the one or more metal- or semi-metal alkoxide monomers and/or one or more partially hydrolyzed and partially condensed polymer thereof in the substantial absence of an alcohol solvent, and then treating with an acid or base catalyst without forming or having formed an emulsion, said inner component not being a pre-formed encapsulate.

14. The encapsulate according to claim 13 wherein the outer shell is essentially free of an emulsifier having an HLB value.

15. The encapsulate according to claim 13 wherein said mixture of metal- or semi-metal alkoxide monomers and/or partially hydrolyzed and partially condensed polymer thereof and said inner component are subjected to high shear of from 600 to 15,000 rpm prior for at least 30 seconds prior to treatment with the acid or base catalyst.

16. The encapsulate according to claim 13 wherein the metal or semi-metal alkoxide monomers include at least tetraethoxy silane.

17. A weight management product having 210 calories or fewer per 1 ounce serving and including the encapsulate according to claim 13.

18. The weight management product according to claim 17 in the form of a nutrition bar.

19. The encapsulate of claim 13 which is formed by dissolving the inner component in the one or more metal- or semi-metal alkoxide monomers and treating with an acid catalyst without first dispersing the monomers to form an emulsion.

20. The encapsulate according to claim 13 which is formed by dissolving the inner component in the one or more metal- or semi-metal alkoxide monomers and mixing with shear in a range of 600 to 20,000 rpm wherein said mixture is essentially free of water prior to doing any of the following optional steps: a) adding water, with or without a catalyst, b) forming an emulsion, c) adding a solvent.

21. A process of forming an ingestible encapsulate comprising mixing one or more metal- or semi-metal alkoxide monomers and/or one or more partially hydrolyzed and partially condensed polymer thereof with one or more components to be encapsulated in the substantial absence of water and in the substantial absence of an HLB emulsifier, then adding an acid or base catalyst, mixing, and neutralizing in the substantial absence of an HLB emulsifier.

22. The process of claim 21 wherein said monomer or monomers and said component to be encapsulated are mixed at a shear rate of from 600 to 15,000 rpm prior to introduction of the catalyst.

23. The process according to claim 21 wherein the monomer or monomers and the component or components to be encapsulated are mixed at a temperature of from 18 to 35 oC.

24. The process according to claim 23 wherein the monomer or monomers and the component or components to be encapsulated are mixed at a temperature of from 20 to 30° C.

25. The process according to claim 24 wherein the component are mixed with the alkoxide or partially hydrolyzed—partially condensed monomer thereof in the substantial absence of alcoholic solvent.

26. The encapsulate of claim 1 wherein said outer shell is resistant to degradation at pH of 0 to 7.1.

27. The encapsulate of claim 1 which is formed by dissolving the inner component in the one or more metal- or semi-metal alkoxide monomers and treating with an acid catalyst without first dispersing the monomers to form an emulsion.

28. A process of forming an ingestable encapsulate comprising mixing one or more metal- or semi-metal alkoxide monomers and/or a partially hydrolyzed and partially condensed polymer thereof with one or more components to be encapsulated in the substantial absence of water and alcoholic solvent and in the absence of an HLB emulsifier, then adding an acid or base catalyst, mixing, and neutralizing.

29. A process of forming an ingestable encapsulate comprising mixing one or more metal- or semi-metal alkoxide monomers and/or a partially hydrolyzed and partially condensed polymer thereof with one or more components to be encapsulated in the substantial absence of water and in the substantial absence of an HLB emulsifier and in the substantial absence of alcoholic solvent, subjecting the mixture to high shear within the range of 600 to 20,000 rpm, then adding an acid or base catalyst in the substantial absence of HLB emulsifier and alcoholic solvent, mixing further, and neutralizing.

30. The encapsulate of claim 1 wherein said outer shell is resistant to degradation at pH of 6.2 to 14.

31. An ingestable encapsulate comprising an outer shell formed from one or more metal- or semi-metal alkoxide monomers and an inner component encapsulated by the shell wherein the encapsulate is formed by mixing the inner component in the one or more metal- or semi-metal alkoxide monomers and/or one or more partially hydrolyzed and partially condensed polymer thereof without forming or having formed an emulsion and without treating with an acid or base catalyst and mixing to a high shear of 600 rpm or greater then treating with an acid or base catalyst.

32. A process of forming an ingestable encapsulate comprising mixing to a high shear of 600 rpm or greater one or more metal- or semi-metal alkoxide monomers and/or a partially hydrolyzed and partially condensed polymer thereof with one or more components to be encapsulated in the absence of an HLB emulsifier, then adding an acid or base catalyst, mixing, and neutralizing.

33. The process according to claim 32 wherein said mixture is subjected to high shear for from 0.5 to 1440 minutes.

34. The process according to claim 32 wherein said mixture is subjected to high shear of up to 15,000 rpm.

35. A process of forming an ingestable encapsulate comprising mixing to a high shear of 600 to 15000 rpm or greater for from 0.5 to 1440 minutes one or more metal- or semi-metal alkoxide monomers and/or a partially hydrolyzed and partially condensed polymer thereof with one or more components to be encapsulated, then adding an acid or base catalyst, mixing, and neutralizing.

36. The active ingredient of claim 1 wherein the active ingredient is a mineral.

37. The active ingredient of claim 36 selected from the group of iron, copper, selenium and zinc and mixtures thereof.
